(19) United States
(12) Patent Application Publication
(10) Pub. No.: US 2009/0218070 A1
(43) Pub. Date: Sep. 3, 2009

(54) Heat Exchange Device and Method for Producing a Heat Exchange Element for a Heat Exchange Device

(75) Inventors: Benedikt Fries, Zell (DE); Axel Loffler, Hohenwart (DE); Christopher Reinke, Gaimersheim (DE)

Correspondence Address: Novak Druce & Quigg LLP, 1300 I Street NW, Suite 1000 West Tower, Washington, DC, 20005, US

(73) Assignee: Audi AG, Ingolstadt (DE)

(21) Appl. No.: 12/400,424

(22) Filed: Mar. 9, 2009

(30) Foreign Application Priority Data
Mar. 7, 2007 (DE) 10 2008 013 134.2

(51) Int. Cl. B60H 1/00; B21D 53/02; F28F 21/00

(52) U.S. Cl. 165/41; 29/890.03; 165/180

(57) ABSTRACT

The invention relates to a heat exchange device, in particular a vehicle radiator, for indirect exchange of heat between a first medium and a second medium, with a first guide section for routing the first medium and a second guide section for routing the second medium, the first guide section being formed by a thermally conductive heat exchange element consisting of graphite foam and being spatially separated from the second guide section, at least part of a second guide section being formed by the heat exchange element. The invention furthermore relates to a method for producing a heat exchange element for a heat exchange device, in particular for the radiator of a motor vehicle.

The invention relates to a heat exchange device, in particular a vehicle radiator, and to a method for producing a heat exchange element for the heat exchange device.

### BACKGROUND OF THE INVENTION

Such a heat exchange device and such a method can already be taken, for example, from U.S. Pat. No. 6,673,326 B1 as known. The heat exchange device which is made as a vehicle radiator is used to exchange heat between a first, conventionally gaseous medium and a second, conventionally liquid medium. The heat exchange device for this purpose comprises a first guide section for routing the first medium which is formed by a thermally conductive heat exchange element consisting of a graphite foam block. To produce the heat exchange element, first a melt mold filled with graphite powder is evacuated and heated to a temperature from 50° C. to 100° C. over the softening point of the graphite powder. Then a pressure of approximately 1000 psi is applied, after which the melt mold is heated to a temperature between 500° C. and 1000° C. Afterwards, cooling to room temperature is done slowly, at the same time the internal pressure being reduced. Finally the graphite foam which has been formed is heated under a protective gas atmosphere to 2800° C., by which the desired graphite foam block is formed. As a result of the porous structure of the graphite foam, the heat exchange element has a very large specific surface, as a result of which, compared to conventional heat exchange devices of metal, improved heat exchange between the two media is enabled and correspondingly higher efficiency can be achieved. The process conditions and the initial material can be varied here such that graphite foam blocks with different pore sizes and shapes can be produced. Then several metal tubes are inserted through the graphite foam block and cemented to it. The metal tubes act as a second guide section for routing the second medium and ensure spatial separation of the two media. The heat exchange device in other words is made as a so-called recuperator for indirect heat transfer. When the vehicle associated with the heat exchange device is moving, air is forced through the first guide section and in the process removes the heat energy from the medium which has been routed through the second guide section, for example, the cooling water of a codling circuit.

The disadvantage in the known heat exchange device is the circumstance that it furthermore has inadequate efficiency in particular for high output requirements and therefore must be dimensioned to be correspondingly larger in order to be able to achieve a specified cooling efficiency. But in addition to a considerable cost increase, this leads to increased demand for installation space and higher overall weight.

The object of the invention is therefore to devise a heat exchange device with increased efficiency and a method for producing a heat exchange element for such a heat exchange device.

### SUMMARY OF THE INVENTION

A heat exchange device with increased efficiency is devised according to the invention by at least part of the second guide section being formed by the heat exchange element. In this way, in contrast to the prior art, it is ensured that heat-insulating boundary layers between the first and second guide section cannot form as a result of tubes, adhesives and the like. In other words, the heat exchange element consisting of graphite foam is made in one piece at least in certain sections and comprises both the first guide section and also at least part of the second guide section. Due to the porous surface of the graphite foam in particular, the capacity of the heat exchange element to convectively release heat is very high. Using the heat exchange element according to the invention, thus especially high heat transfer between the first and second medium can be achieved, as a result of which the heat exchange device has increased efficiency and at a specified cooling efficiency can be made correspondingly more compact and light. Here the first and second medium under standard conditions generally can be liquid and/or gaseous. The heat exchange device is therefore advantageously suited not only for radiators of internal combustion engines, charging air radiators and the like, but also for all applications in which indirect heat exchange between two media is required. This yields significant advantages for costs, weight and installation space. The heat exchange element can moreover be made with a highly variable geometry so that the heat exchange device can be easily integrated into the respective installation spaces with complex geometrical configurations. Possible methods for producing a heat exchange device and a heat exchange element are named below.

Preferably, one surface of the first guide section and/or of the second guide section is coated at least in certain sections with a material. A suitable coating increases the stability of the graphite foam relative to mechanical and chemical influences, as a result of which the service life of the heat exchange device is correspondingly extended. This enables advantageous adaptability of the heat exchange device to different applications.

In one advantageous configuration of the invention it is provided that the material comprises a metal, in particular aluminum and/or copper. In this way high durability of the pertinent guide section on the one hand and good thermal conductivity at low production costs on the other are guaranteed. Moreover, the heat exchange device can be made variable depending on its respective requirement profile and has high chemical resistance to environmental effects.

Other advantages arise by the second guide section comprising at least one channel. This allows structurally simple routing of the second, liquid and/or gaseous medium, and, depending on the configuration of the channel, both laminar and also turbulent flows can be produced. Furthermore, it is possible to design the channel depending on the mass rates of flow of a second medium which occur during operation of the heat exchange device. There can, of course, also be several channels.

Here it has been shown to be advantageous that at least one channel has a width between 1 mm and 5 mm, preferably 2 mm. In this way the required mass rate of flow and flow characteristic of the second medium can be reliably made available with advantageous consideration of the material properties and wall stability of the graphite foam.

The efficiency of the heat exchange device is additionally increased in another configuration of the invention in that the first guide section comprises at least one surface enlargement element, in particular, a depression and/or a rib.

In another advantageous configuration of the invention there is at least one joining element by means of which the first and/or second guide section can be coupled to a fluid line. In this way the mechanical stability and service life of the heat exchange device are further increased, since by way of the joining element which can be produced economically, higher forces can be accommodated than by way of the heat exchange element consisting of graphite foam. In this, way the heat exchange device can moreover be produced structurally more simply since the heat exchange element can be made without joining structures, stiffening or the like. The fluid line is matched to the aggregate state of the respective medium and can be, for example, part of a coolant circuit or heating medium circuit.

In another configuration it has been shown in this case to be advantageous that the joining element consist at least predominantly of aluminum and/or plastic and/or a composite material, in particular, a fiber-plastic composite. This allows mechanically especially stable joining of the heat exchange device to the liquid line with simultaneously low overall weight. Especially for high performance requirements such as, for example, motor vehicle racing this yields especially high cooling efficiency with especially small demand for installation space and low weight. For example, carbon fiber-reinforced or glass-fiber reinforced plastics or, carbon fiber-rock materials can be used as the composite:

Preferably there are two joining elements which are located on the opposite sides, of the heat exchange element and which are coupled to one another by means of a support device. In this way a mechanically especially stable, light, and self-supporting arrangement is devised so that the heat exchange device can be reliably operated even under extreme mechanical and thermal conditions.

Another aspect of the invention relates to a method for producing a heat exchange element for a heat exchange device, in particular for a vehicle radiator, according to the invention its being provided that at least part of a second guide section which has been separated from the first guide section for routing the second medium is produced in one piece with the heat exchange element. This ensures that heat insulating boundary layers between the first and second guide section cannot form, as a result of which improved heat transfer between the two gaseous and/or liquid media is enabled and the heat exchange device exhibits significantly increased efficiency. The method according to the invention furthermore allows dispensing with of additional components such as tubes, adhesives and the like, as a result of which major savings with respect to production time and costs arise. Further attainable advantages can be taken from the preceding descriptions.

In another configuration of the invention it is provided that the first guide section and/or the second guide section be made in the heat exchange element by a metal cutting process, in particular, with geometrically defined cutting edges, and/or by an erosion process. Using a metal cutting process, for example milling or drilling, the graphite foam can be quickly, easily, and flexibly brought into the desired shape by the excess material being removed and the pertinent guide section being produced hereby. Alternatively or additionally, for example, in regions which are poorly accessible or where mechanical machining is not possible, an erosion process can be used. In this connection, one major advantage is very high dimensional accuracy on the one hand and the possibility of producing surface structures with variable roughness or making edges without burrs on the other hand.

Here it has been shown to be advantageous that one surface of the first guide section and/or of the second guide section be coated with a metal. This ensures increased mechanical and chemical stability of the heat exchange element. In addition, this coating is used for sealing of the porous graphite foam against emergence and escape of the respective medium.

Advantageously, the metal is deposited electrochemically on the surface. This constitutes a prompt, simple, and high-quality possibility using the conductive properties of the graphite foam to apply the pertinent metal with an adjustable thickness to the desired surfaces.

In another advantageous configuration of the invention it is provided that a graphite foam with a thermal conductivity value of at least 50 W/Km, in particular, at least 150 W/Km and preferably at least 245 W/Km, be used. In this way the heat exchange device for a specified cooling efficiency can be made especially compact and light.

Other advantages, features and details of the invention will become apparent from the following description of one embodiment and using the drawings in which the same or functionally identical elements are provided with identical reference numbers.

### BRIEF DESCRIPTION OF THE DRAWINGS

FIG. 1 shows a schematic perspective view of a thermally conductive heat exchange element consisting of graphite foam for a heat exchange device;

FIG. 2 shows an enlarged and schematic perspective view of detail II which is shown in FIG. 1;

FIG. 3 shows a schematic perspective view of a heat exchange device provided with the heat exchange element shown in FIG. 1 and FIG. 2;

FIG. 4 shows a top view of a graphite foam material which can be used for the heat exchange element, and

FIG. 5 shows ah enlarged view of detail V which is shown in FIG. 4.

### DETAILED DESCRIPTION OF THE PREFERRED EMBODIMENTS OF THE INVENTION

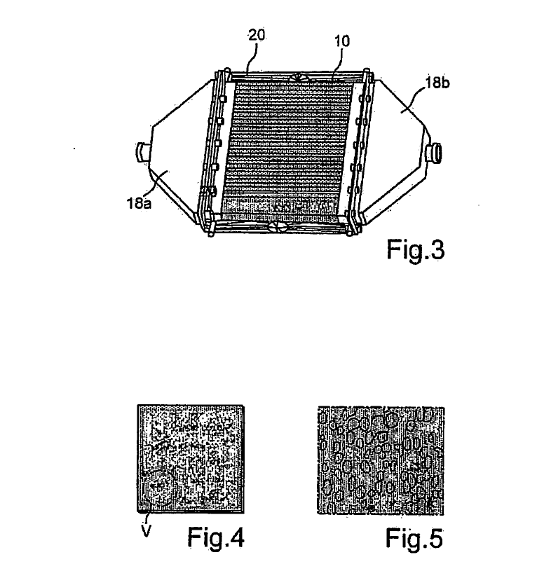

FIG. 1 shows a schematic perspective view of a heat exchange element 10 for a heat exchange device (see FIG. 3) which is made as a radiator for a motor vehicle according to one embodiment. The heat exchange element 10 consists here of a porous graphite foam and is used for indirect exchange of heat between the air as a gaseous first medium and a liquid coolant, for example water as the second medium. For this purpose, the heat exchange element 10 has a first guide section 12a for routing the air and a second guide section 12b for routing the coolant, the two guide sections 12a, 12b being spatially separated from one another by the graphite foam material. The first guide section 12a comprises a plurality of depressions 14 which act as additional surface enlargement elements and which enable passage of air through the porous heat exchange element 10 and thus reduce the resulting pressure loss for flow through the graphite foam. Alternatively or additionally, of course fundamentally one or more cooling ribs or the like can be provided for further enlarging the surface. The second guide section 12b on the other hand has a plurality of channels 16 which each have a width of approximately 2 mm and a length of approximately 15 mm. The first and the second guide section 12a, 12b are made here such that the mass flows of the gaseous and liquid medium cross. This ensures efficient heat transfer between the two media and correspondingly high cooling efficiency of the heat exchange element 10 and of the heat exchange device. The graphite foam of the heat exchange element 10 can be produced, for example, using the method described in U.S. Pat. No. 6,673,328 B1. In this connection, the two guide sections 12a, 12b can be advantageously made directly by using a suitable melt mold during production of the graphite foam and of the heat exchange element 10 at the same time. Alternatively or additionally, it can be provided that first a graphite foam block is produced and the two guide sections 12a, 12b are made subsequently using a metal cutting or erosion process. In this way the heat exchange element 10 can remain in one piece. To further improve mechanical and chemical resistivity, the channels 16 of the second guide section 12b in this embodiment are provided with a basically optional copper coating. The coating can be produced, for example, using a galvanic immersion bath. In contrast to the use of tubes and the like which have been cemented in, which is known from the prior art, it is ensured here that as a result of the small thickness of the coating, the large contact surface between the coating and the coolant and the high thermal conductivity of the copper, correspondingly efficient heat transfer between the two media can take place. Instead of copper of course other materials can also be used, such as, for example, aluminum.

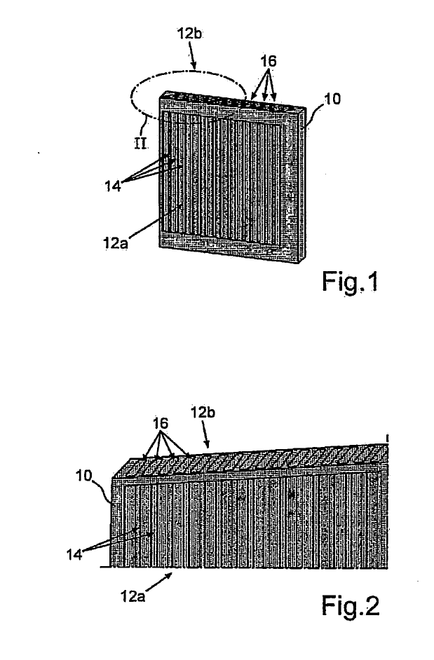

FIG. 2 shows an enlarged and schematic perspective view of detail II which is shown in FIG. 1. Here, in particular, the alignment of the channels 16 of the second guide section 12b within the more or less cuboidal heat exchange element 10 can be recognized. The oblique position of the channels 16 causes an additional improvement of heat exchange with an air mass flow which is at least roughly vertically incident on the heat exchange element 10, since the graphite foam in the region of heat conduction has anisotropic properties and thus the improved heat conduction in one direction can be used at least proportionally better. This leads to a further improvement of the efficiency of the heat exchange element 10 and the heat exchange device.

FIG. 3 shows a schematic perspective view of a heat exchange device which is provided with the heat exchange element 10 shown in FIG. 1 and FIG. 2 for a motor vehicle. On the opposite sides of the heat exchange element 10 there are two joining elements 18a, 18b which are slipped fluid-tight onto the heat exchange element 10. The joining elements 18a, 18b are used for coupling the second guide section 12b to, a fluid line (not shown) of the cooling circuit of the motor vehicle. The joining elements 18a, 18b in this embodiment are made of aluminum and are screwed to one another by means of a support device 20 which consists of lightweight metal rods, as a result of which the heat exchange device is made mechanically stable and self-supporting. As a result of the low weight, compact shape and high efficiency, the illustrated heat exchange device is especially suitable for high performance requirements, for example in motor sports. Fundamentally, the heat exchange device can, however, be used for any applications with indirect heat exchange.

FIG. 4 shows a top view of a graphite foam material which can be used for the heat exchange element 10. In this connection, the product from Poco Graphite, Inc., which is sold under the trade name “Poco HTC” was used as the graphite foam material, and has thermal conductivity property values of approximately 245 W/Km. Moreover, the capacity of the graphite foam material to convectively release heat to the flowing medium due to the porous surface structure is very high. The heat exchange element 10 or the heat exchange device thus enables about 20% higher cooling efficiency with simultaneously reduced overall weight at a specified volume compared to heat exchangers known from the prior art. To further illustrate the structural properties of the graphite foam, FIG. 5 shows a view of the detail shown in FIG. 4 enlarged approximately twenty times. In this instance, especially the relatively uniform pore size and shape can be recognized. Table 1 shows a comparison of mechanical and thermal properties between “Poco HTC” and various other materials. Instead of the indicated graphite foam material “Poco HTC”, however, other graphite foam materials with possibly divergent properties matched to the respective application can of course also be used.

TABLE 1
Comparison of mechanical and thermal
properties of different materials

| | | Thermal | | Thermal | | Heat |
|---|---|---|---|---|---|---|
| | | Conductivity | | Diffusivity | | Capacity |
| | Specific | ⊥ | // | ⊥ | // | ⊥, // |
| Material | Weight | [W/mK] | [W/mK] | [cm²/s] | [cm²/s] | J/gK] |
| Poco/HTC | 0.9 | 245 | 77 | 3.95 | 1.12 | 0.7 |
| PocoFoam | 0.56 | 150 | 45 | 3.69 | 1.22 | 0.7 |
| Copper | 8.9 | 400 | 400 | 1.17 | 1.17 | 0.38 |
| Aluminum | 2.8 | 180 | 180 | 0.69 | 0.69 | 0.9 |
| 6061 | | | | | | |
| Diamond | 3.51 | | 900 | | 5.03 | 0.5 |
| EWC-300/ | 1.72 | 1 | 109 | | | |
| Epoxy resin | | | | | | |
| K321/AR | 1.77 | 20 | 233 | | | |
| Graphite | | | | | | |
| foam | | | | | | |
| Amoco SRG | 1.76 | 20 | 650 | | | |
| Aluminum | 0.5 | 12 | 12 | | | 0.9 |
| foam | | | | | | |

1. A heat exchange device, in particular a vehicle radiator, for indirect exchange of heat between a first medium and a second medium, having a first guide section for routing the first medium and a second guide section for routing the second medium, the first guide section being, formed by a thermally conductive heat exchange element consisting of graphite foam and being spatially separated from the second guide section, wherein at least part of a second guide section is formed by the heat exchange element.

2. The heat exchange device according to claim 1 wherein at least one surface of the first guide section and of the second guide section at least in certain sections is coated with a material.

3. The heat exchange device according to claim 2 wherein the coating material comprises a metal selected from a group consisting of aluminum and copper.

4. The heat exchange device according to claim 1 wherein the second guide section comprises at least one channel.

5. The heat exchange device according to claim 4 wherein one channel has a width between 1 mm and 5 mm.

6. The heat exchange device according to claim 1 wherein the first guide section comprises at least one surface having a configuration consisting of one of a depressor and a rib.

7. The heat exchange device according to claim 1 wherein there is at least one joining element by means of which at least one of said guide sections can be coupled to a fluid line.

8. The heat exchange device according to claim 7 wherein the joining element consists at least predominantly of at least one of aluminum, a plastic and a composite material.

9. The heat exchange device according to claim 7 wherein there are two joining elements which are located on opposite sides of the heat exchange element and which are coupled to one another by means of a support device.

10. A method for producing a heat exchange element for a heat exchange device, in particular for a vehicle radiator, for indirect exchange of heat between a first medium and a second medium, in which the heat exchange element is produced with a first guide section for routing the first medium out of the graphite foam, wherein at least part of a second guide section which has been separated from the first guide section for routing the second medium is produced in one piece with the heat exchange element.

11. The method according to claim 10 wherein at least one of said guide sections is made in the heat exchange element by one of a group consisting of a metal cutting process utilizing a selected cutting bit and an erosion process.

12. The method according to claim 10 wherein a surface of at least one of the guide sections is coated with a metal.

13. The method according to claim 12 wherein the metal is deposited electrochemically on the surface.

14. The method according to one of claims 10 wherein a graphite foam, with a thermal conductivity value of at least 50 W/Km, in particular at least 150 W/Km and preferably at least 245 W/Km, is used.

15. A heat exchange element of a radiator for a motor vehicle comprising a body of graphic foam for conducting a first medium therethrough provided with a plurality of spaced passageways for conducting a second medium therethrough.

16. An element according to claim 15 wherein said passageways are formed by one of the methods of a group consisting of machining, chemical erosion and casting.

17. An element according to claim 15 wherein said passageways are lined with a coating of a metal selected from a group consisting of aluminum and copper.
